(19) United States
(12) Patent Application Publication
(10) Pub. No.: US 2014/0297358 A1
(43) Pub. Date: Oct. 2, 2014

(54) EYES ON CONTROL --- A NOVEL ACCOUNTING SYSTEM

(71) Applicant: Martin Saitzyk, Melville, NY (US)

(72) Inventor: Martin Saitzyk, Melville, NY (US)

(21) Appl. No.: 13/851,664

(22) Filed: Mar. 27, 2013

(51) Int. Cl. G06Q 10/06; G06Q 40/00

(52) U.S. Cl. CPC G06Q 10/0635; G06Q 40/10
USPC 705/7.28

(57) ABSTRACT

A system and method for conveniently dealing with various financial transactions, called Eyes on Control, relates generally to an accounting system and business method with related software programs which is designed to develop a streamlined process to gain a better risk management and more efficient process to run accounting system in terms of cash management, accounts receivable/payable, purchasing, payroll, and general ledger controls.

### REFERENCE TO RELATED APPLICATION

This application claims the benefit of the filing date of U.S. provisional application Ser. No. 61/617,112, entitled “CONTROLLED VISION—A NOVEL ACCOUNTING SYSTEM” and filed on Mar. 29, 2012. The teachings of the entire referenced application are incorporated herein by reference.

### FIELD OF THE INVENTION

This invention relates generally to an accounting system and business method with related software programs which is designed to develop a streamlined process to gain a better risk management and more efficient process to run an accounting system in terms of cash management, accounts receivable/payable, purchasing, payroll, and general ledger controls.

### BACKGROUND OF THE INVENTION

Insurance plays an important role as it provides us reduction of risk exposure. Furthermore, different kinds of risk require different types of insurance. Workers compensation, for example, mitigates the risk of worker injury, while professional liability protects business owners from personal liability.

Protecting and controlling business operations are desired outcomes for business to grow and succeed. Software is a key ingredient in providing the roadmap and ensures the outcomes will be materialized.

What steps does a business take to protect itself from internal financial risk? Certified public accountants are hired to find internal control weaknesses, while consultants review organization hierarchy to better understand company audit controls and verify the proper checks and balances.

As a business grows, these professional services become increasingly necessary, especially as oversight of these internal controls reach beyond the scope of ownership's direct control. These problems are solved by taking all the recommendations; but it takes time to implement. In that same light, upsetting the harmony from organizational disruption during this implementation is a serious concern.

For examples:
Owners, financial executives, and department leaders expect that their direct reports are executing work utilizing a sophisticated process.
Process creation involves the systematic organization of a set of tasks.
Organization is developed by following a set of pre-defined rules.

Thus, instituting a structured computerized process, working concurrently with related accounting software, will accomplish those goals seamlessly.

Having a set of pre-defined processes and controls in accounting system will help avoid risk and material misstatement in business transactions.

Due to various constraints with personnel in this economy, various internal controls may be lacking and the overall oversight for a managed process may cause either misappropriation of funds or lack standardization in the data entry process.

Economic downturn over the past few years has led to a reduction in workforce within businesses across the country. For this reason, a number of the internal oversight controls within small to medium size companies may currently be lacking due to a shortage of manpower. Such reductions in oversight could lead to the breakdown in standard accounting practices and the potential misappropriation of funds.

Streamlined solutions empower managers to focus on the needs of their company without being overwhelmed by the completion of routine tasks. Automation and Standardization is the key ingredient in helping to manage these tasks.

In any business, financial results indicate how well things are going. General ledgers are at the highest level of this accounting hierarchy. This is because it is where all subsidiary ledgers summarize their data. The heart and soul of financial reporting comes from this information. It is clear that there must be procedures in place to ensure data is managed properly and inexperienced staff has guidance. If there were a solution that allowed staff to see the results of their entries before posting, attach their work for review, and report that work to experienced employees for their approval before posting a permanent record, business owners would adopt it accordingly. Automated, computer-assisted processes allow work to move in this standardized manner with efficiency.

Cash management tools allow companies to review balances on a minute-by-minute basis. Wouldn't a tool that automates the overall bank to book balance reconciliation and allow senior people to receive reports of anomalous activity be equally useful?

Purchasing is another process that if left unmanaged can lead to overspending, impacting a company's budget and affecting the bottom line. Why not utilize a tool to compare prices?

Expense reports left without the proper means of recognition and approval can similarly cause overall company spending to increase. However, the proper utilization of a controlled environment, with a systematic process, will create an auditable trail. Having the tools to create this environment will make your life easier.

Consolidating all the pieces and integrating them within the existing environment is necessary in the current accounting world.

### SUMMARY OF THE INVENTION

The invented Risk Reduction Software, called Eyes on Control, is derived from the following:
Ownership & Controls
Used by Owners, CFO's, Controllers, Internal Audit
Define a process—Outline the overall reduction of risk

General ledgers are the king of any accounting system. It is the heart and soul of financial reporting and in many organizations many of the details are left to inexperienced staff people who lack the knowledge and direction to go from Step A to Step B. This invention allows them to see the results of their entries before posting, attach their work for review and report their work to experienced people for their approval, before posting and becoming a permanent record. All of this is an automated process that allows work to move in a standardized process.

Cash management tools were developed within this invention to automate the overall bank to book balance reconciliation and allow senior people to receive reports to detect activity that does not meet their specified criteria. Other tools will report to key individuals relating to cash receipts and cash disbursements.

Purchasing is another process if left unmanaged or without a system of controls can lead to companies spending more, impacting their budgets and causing more money to be spent than necessary. Utilizing the tools in the invented system, price comparisons will be at your fingertips.

Expense reports left without the proper means of recognition and approvals can allow overall spending to be increased. Utilization of a controlled environment will allow those auditable trails to be instilled resulting in approved purchases while eliminating any duplication of expenses.

The following table shows the major functions from the invented Risk Reduction Software:

| | |
|---|---|
| Title | Eyes on Control |
| Purpose | This software will administer a process into cash |
| | management, expense report and general ledger/ |
| | purchasing controls to ensure the methodology of |
| | senior leaders are followed and produce |
| | collaboration and report on deviations from |
| | what was expected. |
| Composition | Cash Management |

Clearing checks, checking fraud or bank error,
cash receipt tracking

Payroll

A defined process for expense reimbursement

General Ledger

Streamline all entry activity with standardization,
documentation and workflow
Provide comparative financial data

Purchasing

Standardized a list for historical purchases

| | |
|---|---|
| Format & | Standard process to be implemented in accordance |
| Presentation | with management process flow. It will be able |
| | to report deviations from norm. |

Normally, business expects the following from its accounting system: enter invoices, enter payroll, print checks, print reports, and produce financial data. However, Risk Aversion is a key ingredient that is missing from any accounting system. Such invented system can prevent fraud, internal error and material misstatement.

The following modules are built into the invented accounting system:

### Cash Management

This module provides an effective method of reconciling and clearing a manual check process in reconciliations. The module enhances the overall reconciliation process from just reconciliation software to an overall cash management system. This system is a two way talk system to an existing accounting cash management module.

This module is critical in tracking and monitoring the inflows and outflows of cash. Cash is one of our most vital assets in which we accumulate the funds from the profitability of our projects. Cash flow and profitability are signs of a healthy company, but without any measurement or alert process, it would be very hard to protect business' No. 1 asset. This system is designed to bring overall accountability to the process. Bank reconciliations are typically administered by young accountants. They are responsible to make sure all the dollars are accounted for and are provided very little oversight. This application will help streamline the process, including saving man hours for the company. A series of bank downloaded transactions will be organized for easy upload into your accounting application. A set of pre-determined criteria will allow exception reporting.

Understanding payment trends helps business to manage cash. Business can use cash flow modeling information as a factor in its bid estimates, negotiations and holding its project teams/owners accountable. Utilization of this front end system will allow business to track payment trends: by owner, by project manager, by project type. It will give business a payment alert for receipts that seem to be delayed outside the typical normal payment range. The system will also allow more transparency amongst the project teams to know when payment is actually received. Project teams are in better position to manage subcontractors and suppliers when they know have been paid or have not.

### Payroll

Expense Reporting

Reimbursing money that employee's outlay is a serious issue that needs to be addressed timely manner. Differing interests, project completion and issuance of payroll checks sometimes collide. The pressure to move the project along forces employees to take money out of their own pocket. The lack of time to reimburse money to those employees' forces business to go outside the normal protocol, rather than if the business paid an outside vendor. Documenting the process for reimbursable items eliminates confusion, gains accountability and eliminates the judgment of gray areas. If business owners put a process in place, it will force their policies to be reinforced and take it outside of people's hands that are not empowered to make those decisions anyway.

Software will provide mechanism to track receipts, organize transactions by pay/vendor type. It will generate an upload file after approval process to export to a payroll system.

### General Ledger

How people sort out their information through their brains? It's a planned, evaluated process. The general ledger is the brain of the accounting system and it has its own set of rules.

If you can picture entrusting your accounting system to sophisticated professionals without an instruction manual, you will find many of them will figure out a way to get it done. It is highly unlikely any those processes will be the same. Now imagine the ones who don't figure it out and the amount of time and effort it would take to trace those entries to get you back to square one.

Accounting professionals understand the necessity to balance the books, but without process and controls, it can lead to inefficiencies. As the financial person in business organization, you may do everything yourself, but without a set of rules to follow you may end up questioning yourself, “Why did I do that?”

If the financial person engages the invented system to work within the process, the following benefits will happen:
Documents will be easier to find
Analysis will be shared
Workflows will allow others to collaborate
Overall month closing process will be more efficient.

The month end is a stressful time and with any breakdown in the steps, errors will occur. It will lead you to questioning your internal systems and controls. Providing a process flow baseline will allow research to be completed in a routine way, allow collaboration/discussion and inherently saving you time. Time is an asset once lost, never regained.

This system will organize each batch of entries under entry type, allow approval workflows and generate links to ledger balances that incorporate with excel based calculations. It can then be easily uploaded to the accounting system while attaching the trailing documents. In addition, it will organize transactions for historical trends to make business decisions.

### Purchasing

Understanding the cost will help to obtain the lowest bid over competitors and will be key to winning projects. Once being awarded those projects, maintaining a good record keeping system of the cost of materials will keep business on budget and keep business profitable.

Keeping a good historical record of the vendors would help business owners easily to know when they bought the material and the price they paid should be at your fingertips. People should never assume the project teams are pricing competitively, as their goals are to build a job, while cost people want it to be built within budget.

Having an easy, reliable source of data, at everyone's fingertips will make the team work cohesively. Once these goals are mirrored, the data works its way back into the estimating process which will allow a more effective bid process.

Utilizing a simplistic approach with field teams will allow buy in, gain understanding of what the goals are and make the paperwork less onerous.

### DETAILED DESCRIPTION OF THE PREFERRED EMBODIMENTS

The present invention provides a system and method for conveniently dealing with various financial transactions, called Eyes on Control, relates generally to an accounting system and business method with related software programs which is superior to any accounting software or program available in the market and is designed to develop a streamlined process to gain a better risk management and more efficient process to run accounting system in terms of cash management, accounts receivable/payable, purchasing, payroll, and general ledger controls. Its business applications include but not limited to Cash Management, General Ledger Approval, Purchase Order Control, etc.

This novel accounting system consists of multiple modules as described below:

### Cash Management Module:

This module provides an effective method of reconciling and clearing a manual check process in reconciliations. The module enhances of the overall reconciliation process from just reconciliation software to an overall cash management system. The system is a two way talk system from an existing accounting system to the cash management module and back to the accounting system.

Currently all checks are manually cleared. The module is designed to develop a mechanism to streamline the bank reconciliation, which includes the following steps:

Setup→Tasks→Reports

### Setup:

### Bank Name

### ABA

### Account Number

General Ledger Account→Pre-populated from existing ODBC script into new system

### Contact Person

Email address

### Tasks:

1) Clear checks
System will take .csv file and organize structure of file for import.
   Programming setup—Take .csv file and customized mapping.
   Knowing bank provider will make for easy install. (All mapping previously setup).
      2) Import credit card activity
Programming setup—Map line by line description formats as well as cardholders' name
Transfer—Pick “x” bank to “y” bank.
   3) Edit register
Mimic edit register with pre-defined numbering system for easy reference
   Setup month end (auto generate from application) and defined template for type of entry.
      Withdrawal
      Additions
      Adjustment
         4) Deposit mapping—linkage to ODBC to pull A/R open balances (open behind the scenes, but not upon opening the application, click on “Create linkages to accounting system”.
Enter and map to Job Cost or Accounts Receivable module.
   Job Cost—map to job
   Non A/R—handle non job activity to vendor activity file
Trend cash receipt cycles
   Average days to collect by job/client.
      5) Set conditions on expected collections to build in auto reminders. Set defined user list to let certain users know on “x” date who should be notified.

### Reports:

Pay trending to vendors
   Average time to pay based on invoice date/received date.
   Build reports for alerts
      The Cash Management Module can play the following functions:
It is built to select invoices for payment:
   Alerts by job
   Approval by management
      Route to inform users that certain vendors have been selected for payment.
      When check run is approved, create an email list to alert vendors that they have invoices approved are in the check review/signing process.
         OVERIDE—turn off certain vendors not to be selected.
   Build comments next to invoices for areas of concern or special requests
   Attach note to be included with approved check run
      Generate paper and email notes to vendors
   Attach to accounting system all note histories
ACH option
   Create ACH payments
      Upon approval .exe file created for uploading to bank
Payroll Tax Creation—Create A/P Manual Check
Taxes
   941 upload and creation
      Weekly input file for quarterly filing
   Part of bank download
      Create recognizable import file tagged to Schedule B
   Run accounting system report
      Create .exe file to CM program to create Schedule B and determine refund/payment due
   Expand to other tax filings
      State withholdings, SUI, FUI
         The Cash Management Module has the following process:
1) Work with all major banks to develop a readable format to import the transactions into a table for easy clearing. Very simple setup using .csv import file. .CSV file will be setup based upon bank download and converted into an existing accounting system readable format.
   The reporting format is developed with some flexibility. Options are to have bank build (customary) or IT help.
   Transactions can be imported as often as you wish into multiple bank accounts with minimal setup.
   Savings benefits
      a. Time management
      b. Headcount
      c. Accuracy
   Value added benefits
      a. Exception reporting
      b. Risk aversion
      c. Reporting
      d. Fraudulent activity
2) Managing transaction activity
   Build a library of:
      a. Who gets paid?
      b. How often they get paid?
      c. Allow field access to cash management system without direct access into an existing accounting system (improved security). Field users can utilize the system to see when certain vendors are paid.
         i. Library of information—Job level and vendor level.
      d. Allow direct email links to alert accounting to request a stop payment or to let them know when certain payments should be held.
3) Bank Balance Activity
   Understand your balance
      a. As more activity is entered into the system you will build a knowledge database.
         i. Cash alerts—pre-determined thresholds
         ii. Collection trends—traced by job, agency or customer. Receipts are exported into A/R module or J/C receipt module.
         iii. Cash forecasting tools—system will allow you to build a template of expected receipts with dates of collection, Accounts payable prompts will ask when certain payments are made (utilize accounts payable vendor aging system or manually enter assumptions). These tools will allow you to build a forecast. System will allow forecasting by job with a consolidated rollup.
4) Cash Receipts
   Import activity based transactions for billing.
      Help build library of pay trends by job and by customer.
      Allow accessibility to only registered members.
      Build alerts to team members who need to know when these collections happen (senior management, project team, accounting, etc.).
         Such module can bring in the following benefits:
1) Daily import of cleared transactions allowing you to know your bank to book balance at any time.
2) Vendor history—System is reportable to allow users to identify how often specified vendors are paid. System will also identify based upon received date when certain paid bills are outside the normal pay cycle.
3) Company alerts—System will alert various identified users when book balances are below certain thresholds based upon reconciled transactions.

### Accounts Receivable Module:

Within this module, a library is built to report to users when payments are received.

### Accounts Payable Module:

This module allows users to approve vendors for payment in relation to cash flow and allow comments to be directed to vendors in the disbursement of funds.

### General Ledger Module:

This module provides an effective method of audit trail of general ledger/direct job cost entries. The system will build a library of entries. In such process, it is able to report which entries were made, by whom and who had approved them. It also alerts the user which entries have not been made within a specified time limit. The audit trail is a very effective internal control tool to be utilized by senior management and internal/external auditors. The module also provides audit schedules that compare transaction variations over a specified period. In addition, it can be used in scenarios before posting of transactions.

Due to the current issues of direct access and limited controls, this module is designed to develop a mechanism to streamline the activity in the approval process of a general ledger entry or direct cost entry, which includes the following steps: Setup→Tasks→Reports

### Setup

### Workflow

1^{st} level approvers
   We can pick group level security off an existing accounting system
      i. Front end security
         1. It is built from the system.
      ii. Back end security
         1. An existing accounting system reject postings from unauthorized users
Assign 2^{nd} level approvers
   Add up to 10 levels if necessary
Final approval→route to posting→typically manager or controller
Entry types
   Setup comes with fixed definitions
   Can add more as an option
   Pre-defined types
      PR—To post current month payroll activity.
      OPE—To post current month operating activity.
      INV—To post current month investment activity.
      MMA—To post current month money market activity.
      BIL—To post current monthly billings.
      DEP—To post current monthly deposits.
      JV—To post current joint venture monthly activity.
      CTC—To post current month cost to cost entry.
      BC—To post back charge activity.
      ADJ—To post current month adjustments.
         1. Push current month/year into description
      Example—CTC→4 Pull ending balance utilizing ODBC, input new balance, generate calculation
Setup defined descriptions for entry types
   See as noted above; description next to entry type; ex. PR—To post current month payroll activity.
View transaction entries connected utilizing ODBC to see how entries will look before posted.
   Enhance control over entries before error of input.

### Tasks

Enter journal entry
   Use the style of grid for entry
      Drop down menu of entry defined type
      Account numbers pulled from an existing accounting system (Connect using ODBC)
         Debit/Credit
      Journal Entry #—If available from setup—pre-fill
      Reference 1—Generate “YR”—Entry Type—“MTH”
      Reference 2—Workflow approval—Initials—AUDIT FEATURE
      Description—Pull down defined description, add a new defined description
      Attachments—Attach documents to map to accounting system.
      Finish—Go to workflow approvers
      Attachments—Push into accounting system—Approvers, comments, documentation.
         Pre-built tables for autofill
         BIC/CIB—Possible link to balances, plug in current balance, calculation or enter starting balance, plug in current balance, calculation.
         Consolidation—calculate month over month variances for calculation.
         Attach backup for entries

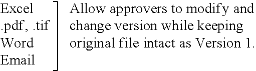

Approval—Allow approvers direct email to ask for clarification with email attachment of documents.
Allow reject of prepared entry
Comment Section: ______

### Reports

Entries by type
Entries by initiator
Entry by date range
   The General Ledger Module has the following process:
1) Build an auditable track, workflow approval system. Attach relevant documents to validate entry.
   System imports all general ledger account numbers.
   System will allow entry for debit and credit activity.
      a. Will ask for relevant schedules to be attached. Format can be spreadsheet, .pdf or word based. Excel attached can be imported and exported. Benefits on exported worksheets allow other users to benefit from colleagues workups. Reduce time to re-create spreadsheets and formulas. Allow an auditable trail for how information is linked
   Utilize attachments to view audit logs and entry backup.
2) Workflow
   Build a workflow of approved transactions.
      a. Auditable trail
      b. Gain acceptance from peer review
      c. Reject and ask for relevant documentation
      d. Build library or required end of month transactions
         i. Run reports to see all required entries have been imported.
         ii. Pre built alerts to user group with defined time limits.
         iii. Consistency of labeled entries. All payroll entries have same tag line with accounting date stamp.
3) Audit Workpaper Comparisons
a. System will automate a library of transactions that summarize activity within general ledger accounts based upon vendor name. This reporting mechanism will allow you to compare activity within a date specified range.
   i. Month to Month
   ii. Year to Year
b. Data compilation with .exe file—Search (Rev) “Reverse entries” and Replace with a “ ” (Blank)
i. Subtotal by vendor and by period
   ii. Percentage allocation of total of G & A account
   iii. Graphically present data
      Trend by year—percentage increase by total/vendor
Setup—Need to read general ledger data and map back into general ledger program—possible .sql sort.
4) Sales Tax Filings
   Input invoices for “use tax”
      Anything to recognize from accounting system
      Create scanned document for transfer
   Prepare report for filing
      The General Ledger Module can bring the following benefits—Be able to map meaningful charts.
Payroll trending
Audit trail
   Documented approval process
   Ability to review staffs work
      Who understands what they are doing/Who needs help?
      Preview impact of entries before finalizing. Less input errors.
   Prevent fraud
      Understand flow of transactions
      Segregation of functions
         Small companies—multi tasked staff do not allow segregation. This is a chance for a management review.
         Larger companies—create different workflows for different departments.
         Payroll—Post payroll—created tax entry
         Cash Management—makes transfer

### Purchase Order Management (Job Cost) Module:

This module provides an effective method for importing purchase order transactions for use in comparison in the approval of invoice process. It is an effective recording from a historical view of amounts paid from a range of vendors for specific products.

The module includes the following steps: Setup→Tasks→Reports

### Setup

Setup job with all screens from accounting system.
   Setup easy structure for key fields
   Project manager access
Access by project manager or group for related jobs.
Build front end purchase order entry
   Ability to map from any program (ex. Contract manager, primavera, construct ware)
   Push purchase order data into an existing accounting system—schedule a script (for auto run)
   Subcontract template—Import standardized language, add various specification sections, certain contract terms
      Allow for easy research to find sections.
Setup pre-built groupings

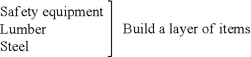

Search for best pricing for

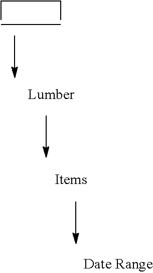

Result→Able to click and sort by Vendor, Item & Price

### Tasks

Entry of purchase order using a pre-fix of job number and a combination of company business rules.
Long form purchase order entry workflow.
   Build approval workflow before contract issuance.
      Approve, Reject: Comments
   Standard Language upload
      Go through various edits for language inclusion
      Print professional final document
         Email for signature
         Email return (.exe file) for system approvals into accounting system.
         Alert team of final approved document.
Incorporate screenshots for point of entry or if using other data source build importable format.

### Reports

Purchase order front end
   Build database by item for comparison pricing
   3 quotes—Vendor, item, amount, quote (attachment to accounting system)
      (Another great tool for auditable activity)

### Payroll Module:

This module is designed to organize an approval process for expense reimbursements. Such system will track acceptable week ending dates to help eliminate duplicate payments for expenses previously approved.

### Expense Reporting

Interface system to report reimbursement of expenses.
Expense type:

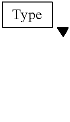

System Setup—Login name would be linked to employee ID.

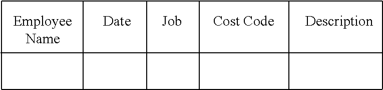

Setup—Should be linked to accounting system table
   Types
      Auto Allowance
      Reimbursement Entertainment
      Reimbursed Travel
      Meals
   Pick Type

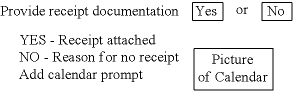

YES/NO—Description of Event
   Attendee list
   Save each line item
Route to approvers
   Easy flow chart setup—Employee, Manager, Supervisor, Payroll
   Dollar value thresholds.
Push to accounting system
Push entries into system and keep as the receipts as attachments.
Reports
   Print reports by type, job, and filter fields.
   Downloadable to excel
   Review previous approvals

From the above detailed descriptions, the invented accounting system, including multi-module application software packages, is not just improved but is integrated and powerful since it combines most of aspects or fields in accounting area and let them work together systematically, including general ledger, expense management, cash management, job costing, etc. It provides business an ideal environment to process, review, and react with controlled system and less risk. The process menu contains processing bank transaction, preparing journal entries, organizing expense reports, and making purchase orders. For example, the journal entry includes proposing debits and credits with supporting documentation (attach .pdf, .tif, .doc, .xls files to support journal entry), then view impact of those entries and build a decision tree for Yes/No results to accept. Such journal entry template could include Date, Account, Debit, Credit, Sub Ledger, Reference, Account to Debit, Account to Credit, and Description. The risk management within this system including the following components: General Ledger, Cash Management, Expense Tracking, Purchase Order, Compliance, Legal Action, Advisory, Investigative Process, etc.

In summary, the present invention provides a novel, unique and systematic method to consolidate all the related accounting processes or financial transactions. The Eyes on Control may be of considerable interest to accounting professionals and related programmers, who may seek to slightly modify one or more elements of the Eyes on Control in order to use the Eyes on Control for their particular applications. Although the Eyes on Control and the methods of using the accounting system have been described in the foregoing specification with a number of details, it is to be understood that modifications may be made to the invention which do not exceed the scope of the invention and, modified forms of the present invention done by others skilled in the art to which the invention pertains will be considered infringements of this invention when those modified forms fall within the claimed scope of this invention.

What is claimed is:

1. A controlled accounting system for risk management comprising: cash management module, accounts receivable module, accounts payable module, general ledger module, purchase order management (job cost) module, and payroll module, wherein a business management software program is integrated and combines all said modules systematically.

2. A controlled accounting system for risk management of claim 1, wherein said cash management module provides an effective method of reconciling and clearing a manual check process in reconciliations, wherein cash management module is a two way talk system from an existing accounting system to said cash management module and back to the existing accounting system.

3. A controlled accounting system for risk management of claim 1, wherein said accounts receivable module consists of a library built to report to users when payments are received.

4. A controlled accounting system for risk management of claim 1, wherein said accounts payable module allows users to approve vendors for payment in relation to cash flow and allows comments to be directed to vendors in the disbursement of funds.

5. A controlled accounting system for risk management of claim 1, wherein said general ledger module provides an effective method of audit trail of general ledger/direct job cost entries based on a built library of entries, wherein said general ledger module reports which entries were made, by whom and who had approved them, alerts the user which entries have not been made within a specified time limit, provides audit schedules that compare transaction variations over a specified period.

6. A controlled accounting system for risk management of claim 1, wherein said purchase order management (job cost) module is an effective recording from a historical view of amounts paid from a range of vendors for specific products and provides an effective method for importing purchase order transactions for use in comparison during the approval of invoice process.

7. A controlled accounting system for risk management of claim 1, wherein said payroll module tracks acceptable week ending dates to help eliminate duplicate payments for expenses previously approved and is designed to organize an approval process for expense reimbursements.

8. A business method of using said controlled accounting system for risk management of claim 1 to gain a better risk management and more efficient process to run accounting system in terms of cash management, accounts receivable/payable, purchasing, payroll, and general ledger controls.
